(19) United States
(12) Patent Application Publication
(10) Pub. No.: US 2009/0265208 A1
(43) Pub. Date: Oct. 22, 2009

(54) METHOD FOR OUTSOURCING TECHNOLOGY BASED SERVICES

(76) Inventors: Stephen M. Pratt, Palmer Head (NZ); Gregg Lymbery, Wellington (NZ); Simon Fisher, Tauranga (NZ)

Correspondence Address: UNISYS CORPORATION, UNISYS WAY, MAIL STATION: E8-114, BLUE BELL, PA, 19424, US

(21) Appl. No.: 12/330,553

(22) Filed: Dec. 9, 2008

(30) Foreign Application Priority Data
Dec. 10, 2007 (NZ) 564197

(51) Int. Cl. G06Q 10/00; G06F 3/048; G06Q 50/00

(52) U.S. Cl. 705/9; 715/705; 705/7; 715/780; 715/845

(57) ABSTRACT

A computer implemented method of defining the outsourcing of technology based services, the method including the steps of: defining a plurality of technology based services that are to be provided by one or more service providers to a customer; defining a plurality of activities associated with the services; displaying the services and activities on a graphical user interface; detecting a selection of one of the activities; and displaying further information on the interface based on the selected activity, wherein the further information provides a guide on how to define the outsourcing of the selected activity.

### RELATED APPLICATIONS

The present application claims the benefit of commonly assigned New Zealand Provisional Patent Application entitled “A Method for Outsourcing Technology Based Services”, Serial No. 564197, filed Dec. 10, 2007, which is incorporated herein in its entirety.

### FIELD OF THE INVENTION

The present invention relates to the outsourcing of technology based services. In particular, the present invention relates to a method of defining the outsourcing of technology based services, validating metric data during the outsourcing of technology based services and providing interaction information when defining the outsourcing of technology based services.

### BACKGROUND

Services provided, and processes implemented, by a business entity can be defined according to the delivery practices of the supplier, experience, good practice and with reference to relevant external standards such as ITIL (Information Technology Infrastructure Library) standard. A number of activities are associated with each process or service. The service activities are defined by a task or tasks using task lists. The process activities are defined using a procedure or procedures. For each of the activities, whether it is a service or process, or for each task list or procedure, an environment can be defined which represents a subset of the total technology operated by the client. The client's business environment can be defined as a set of technology environments that collectively support the business environment. Technology environments can be defined in a multitude of different ways. For example, the environment can be defined by technology area, by geographical location or by functional business units of the client's business.

For the purposes of the following description and the claims, the use of the term task or tasks is herein intended to include either a task or tasks related to service activities, and a procedure or procedures related to process activities.

In order to aid the process of arranging for the outsourcing of technology based services, the present applicant has devised a joint responsibility matrix (JRM) tool. This tool enables the user of the system to more easily determine the needs of the client in relation to the provision of, and agreements related to, outsourced technology based services across the client's business environment. By determining the needs of the client and putting the requirements and agreements associated with those needs into a defined structure using the JRM tool, a contract for technology based services to be provided by outsourced entities is more easily obtained. Further, the contract can easily be modified by making the appropriate changes using the tool. This ensures that the changes are inserted and incorporated fully within the contract at the appropriate place, with relative ease compared to a manual change of a contract.

Using the JRM tool information is obtained from the client by the user of the tool taking into account the client's requested activities, their business environment, the types of technology that are to be used, as well as the geographical areas covered by the client's business and the particular business units in which the services are to be provided. The user of the system is required to deduce from conversations with the client all the relevant information associated with the outsourcing of the services. In certain cases, this can lead to information being overlooked or mismanaged. This in turn can result in the need to re-organise or redraft the contract to incorporate new information.

The present invention aims to overcome, or at least alleviate, some or all of the afore-mentioned problems, or to at least provide the public with a useful choice.

### SUMMARY OF THE INVENTION

In one aspect, the present invention provides a computer implemented method of defining the outsourcing of technology based services, the method including the steps of: defining a plurality of technology based services that are to be provided by one or more service providers to a customer; defining a plurality of activities associated with the services; displaying the services and activities on a graphical user interface; detecting a selection of one of the activities; and displaying further information on the interface based on the selected activity, wherein the further information provides a guide on how to define the outsourcing of the selected activity.

In a further aspect, the present invention provides a computer implemented method of validating metric data during the outsourcing of technology based services, the method including the steps of: defining a plurality of technology based services that are to be provided by one or more service providers to a customer; defining elements of a business environment in which the technology based services are to be provided and arranging them in a hierarchy; displaying metric information for the selected element; enabling metric data for the elements of the business environment to be received; and determining if any received metric data is valid across the hierarchy of the business environment.

In yet a further aspect, the present invention provides a computer implemented method of providing interaction information when defining the outsourcing of technology based services, the method including the steps of: defining a plurality of technology based services that are to be provided by one or more service providers to a customer; defining a plurality of activities associated with the services; defining elements of a business environment in which the technology based services are to be provided; displaying the services, activities and elements of the business environment on a graphical user interface; and displaying a graphical indication of the direction of interaction between any two entities, wherein an entity is one of a service provider or the customer.

The present invention has improved the JRM tool by including further functionality to enable the retrieval of more specific, relevant and focussed data and to check the validity of certain data that is provided. Further, the tool has been improved to provide enable the interaction status of certain entities to be more easily determined.

### BRIEF DESCRIPTION OF THE DRAWINGS

Embodiments of the present invention will now be described, by way of example only, with reference to the accompanying drawings, in which:

FIG. 1 shows a conceptual diagram for defining the outsourcing of technology based services;

FIG. 2 shows a screen shot of the JRM tool according to an embodiment of the present invention;

FIG. 3 shows a system block diagram for implementing an embodiment of the present invention;

FIG. 4 shows an example of further information in the form of comments or examples that are relevant to a selected activity according to an embodiment of the present invention;

FIG. 5 shows an example of further information in the form of questions that are relevant to a selected activity according to an embodiment of the present invention;

FIG. 6 shows an example of further information in the form of metrics that are relevant to a selected activity according to an embodiment of the present invention;

FIG. 7 shows an example of further information in the form of tasks that are relevant to a selected activity according to an embodiment of the present invention;

FIG. 8A shows a screen shot of the JRM tool indicating elements of an environment based on technology according to an embodiment of the present invention;

FIG. 8B shows a screen shot of the JRM tool indicating elements of an environment based on geographical area according to an embodiment of the present invention;

FIG. 8C shows a screen shot of the JRM tool indicating elements of an environment based on business units according to an embodiment of the present invention;

FIG. 9 shows a screen shot of an environments editor according to an embodiment of the present invention;

FIG. 10 shows an example of further information in the form of comments or examples that are relevant to a selected activity and element of the environment according to an embodiment of the present invention;

FIG. 11 shows an example of further information in the form of questions that are relevant to a selected activity and element of the environment according to an embodiment of the present invention;

FIG. 12 shows an example of further information in the form of metrics that are relevant to a selected activity and element of the environment according to an embodiment of the present invention;

FIG. 13 shows an example of further information in the form of tasks that are relevant to a selected activity and element of the environment according to an embodiment of the present invention;

FIG. 14 shows an example of further information in the form of comments or examples that are relevant to a selected activity, element of the environment and tagged item according to an embodiment of the present invention;

FIG. 15 shows an example of further information in the form of questions that are relevant to a selected activity, element of the environment and tagged item according to an embodiment of the present invention;

FIG. 16 shows an example of further information in the form of metrics that are relevant to a selected activity, element of the environment and tagged item according to an embodiment of the present invention;

FIG. 17 shows an example of further information in the form of tasks that are relevant to a selected activity, element of the environment and tagged item according to an embodiment of the present invention;

FIG. 18 shows a screen shot of a task properties entry screen according to an embodiment of the present invention;

FIG. 19 shows a screen shot of a service level data input screen according to an embodiment of the present invention;

FIG. 20 shows a screen shot of the hierarchy of an environment according to an embodiment of the present invention;

FIG. 21A shows a screen shot of an interaction indicator between parties within one element of an environment for a single activity according to an embodiment of the present invention;

FIG. 21B shows a screen shot of an interaction indicator between parties for different elements of an environment for a single activity according to an embodiment of the present invention;

FIG. 21C shows a screen shot of an interaction indicator between parties within one element of an environment over different activities according to an embodiment of the present invention;

FIG. 21D shows a screen shot of the display of further interaction information according to an embodiment of the present invention.

### DETAILED DESCRIPTION OF THE INVENTION

### First Embodiment

The present invention will be described in relation to the outsourcing of information technology based services. However, it will be appreciated that the invention may also be adapted for use with the outsourcing of any other service, whether it is technology based or not.

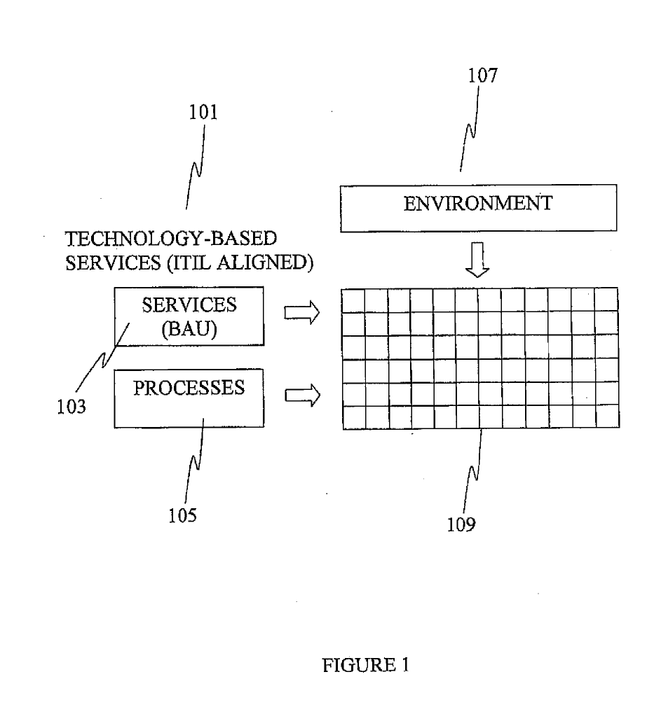

FIG. 1 shows a conceptual diagram for defining the outsourcing of technology based services 101. Technology based services 101 are defined in terms of services 103 that are to be supplied during normal business operation, i.e. business as usual (BAU) services, as well as processes 105 that are to be implemented when a particular event occurs.

The client's business environment 107 is defined in order to provide a context in which the technology based services are to be provided across the organisational environment 107. That is, an organisation is defined in terms of groups of elements that make up the organisation. This could be, for example, different operational departments or business units within the organisation, different locations or geographical areas of offices of the organisation, or different technological elements of the organisational environment. Any suitable definition may be used. In this manner it is possible to produce a matrix of responsibilities for certain processes and services in the organisation according to the defined groups of elements. The processes and services are defined in line with a common standard, such as, for example, ITIL (Information Technology Infrastructure Library).

Using the JRM tool, a responsibility matrix 109 is produced to identify the parties that are responsible for providing the technology based services within the organisation.

One example of a responsibility matrix shows that the client's or organisation's environment is grouped into separate elements such as payroll systems, messaging systems, application systems etc. At each intersection point in the matrix, the party responsible for providing the service or implementing the process for that part of the environment is identified. For example, the appearance of the intersecting box may be changed according to a predefined list of icons associated with the service providers or client, where each service provider and the client are defined by a particular colour or pattern. Alternatively, or as well as the change of box appearance, the name of the responsible service provider may be inserted in the intersecting box. It will be understood that there may be one or more service providers and that certain services may be provided by the client themselves.

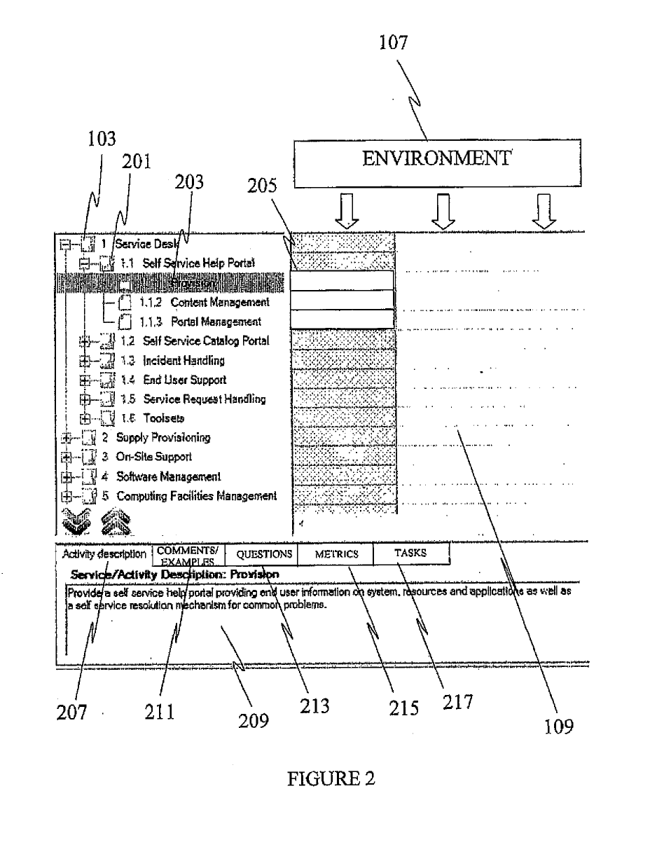

FIG. 2 shows a screen shot of the JRM tool according to this embodiment. The tool is displayed on a graphical user interface (GUI). A list of services 103 is provided in a left hand pane of the display. For example, as shown in FIG. 2, the services 103 may include, but are not limited to, Service Desk, Supply Provisioning, On-Site Support, Software Management and Computing Facilities Management.

For each service 103, a number of activity headings 201 are provided. For example, for the Service Desk service, the Self Service Help Portal, Self Service Catalog Portal, Incident Handling, End User Support, Service Request Handling and Toolsets activity headings are provided and displayed.

Under each activity heading 201, a number of activities 203 are identified. For example, under the Self Service Help Portal activity heading, Provision, Content Management and Portal Management activities are provided and displayed.

As explained above, the JRM tool includes a responsibility matrix 109, which, with reference to different elements of the client's business environment 107, enable the user of the JRM tool to define the responsible parties for the provision of the listed activities 203. That is, at each intersection point 205 between activities 203 and an element of the environment 107, an entity is identified.

When a user selects an activity, for example, the “Provision” activity as part of the Service Desk service, further information is provided in a lower pane 209 of the GUI. The further information includes an activity description 207, comments or examples 211, questions 213, metrics 215 and tasks 217. The user selects the relevant tab in order to display any of these types of further information.

The purpose of the further information is to provide a guide on how to define the outsourcing of the selected activity. Also, the further information is used to assist with the preparation of the contract for the outsourcing of technology based services. In addition, the further information improves the quality of the contract created by enabling more detailed focus on the issues at hand and by ensuring that minor details that may result in major problems later are not overlooked. Further, the tool may also be used to enable due diligence to be carried out on a business entity.

For example, the activity description tab 207, when pressed, provides a legally acceptable description of the activity selected. That is, the terminology used is aligned with the required contractual terminology that will be implemented in the final contract.

In the example shown in FIG. 2, the selected activity is the “Provision” activity for the Service Desk service. The further information displayed when selecting the activity description tab 207 states:

“Provides a self service help portal providing end user information on system, resources and applications as well as a self service resolution mechanism for common problems”

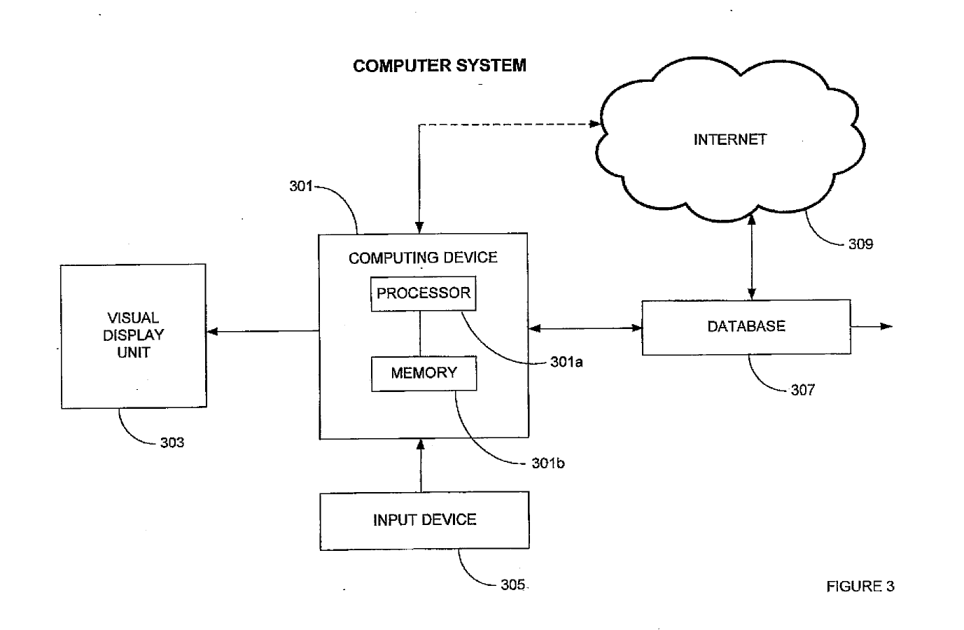

FIG. 3 shows a system block diagram for implementing this embodiment.

A computing device 301, such as a personal computer for example, including a processor 301A and memory 301B is used. In this embodiment, the computing device has a visual display unit 303 connected to it that is capable of displaying the GUI. Further, input devices 305, such as a keyboard and mouse, are connected to the computing device 301. Computer software arranged to implement the method described herein may be stored on a suitable medium such as the computer memory 301B. The computing device may also be in communication with an external database 307 and/or other computing systems directly, or over a network, such as the Internet 309. It will be appreciated that the system can be developed using one of any number of programming languages and can be deployed within many different hardware configurations.

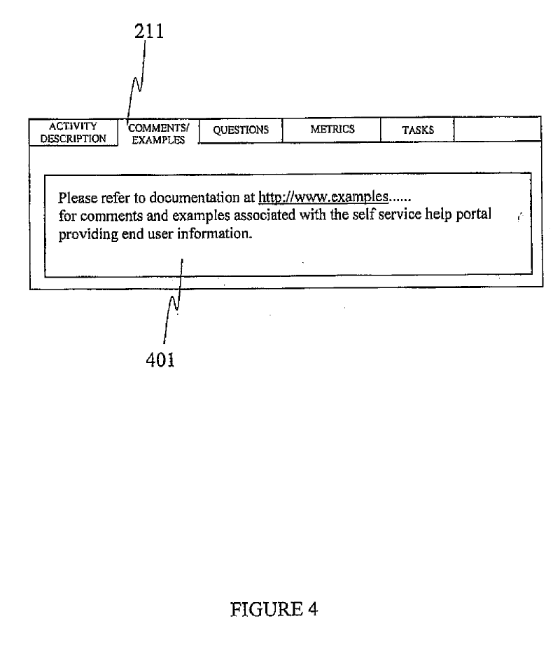

FIG. 4 shows an example of further information in the form of comments or examples, which are relevant to a selected activity. A user selects an activity 203 using the GUI, as shown in FIG. 2, and then selects the comments/examples tab 211. The processor 301a detects the selection point on the matrix using techniques well known in the art. Further information 401 is then provided in a text box within the lower pane of the GUI.

In this example, the further information 401 provided gives the user examples and comments that are related to the selected activity. That is, relevant comments and examples associated with the selected activity are retrieved from the database 307 and displayed. This information enables the user to more easily understand and determine with the client whether the activity is relevant to the client's business by discussing the examples and reviewing the comments. For example, the information 401 can direct the user to relevant documentation in the form of a website link, which, in the case of the “Provision” activity being selected will provide examples and comments associated with the Self Service Help Portal providing end user information.

In a further example, the comments and examples screen could provide text identifying that the particular activity could use a particular tool from a particular vendor, or that it is usual to produce weekly reports in a certain format. Examples of the format can then also be provided along with a list of tools and associated vendors.

Further, the comments and example information may include previously produced reports associated with the selected activity, tools previously used to carry out the selected activity, a list of clients who have previously implemented the activity, photographs, charts, graphs, multimedia or links to alternative sources of information associated with the selected activity.

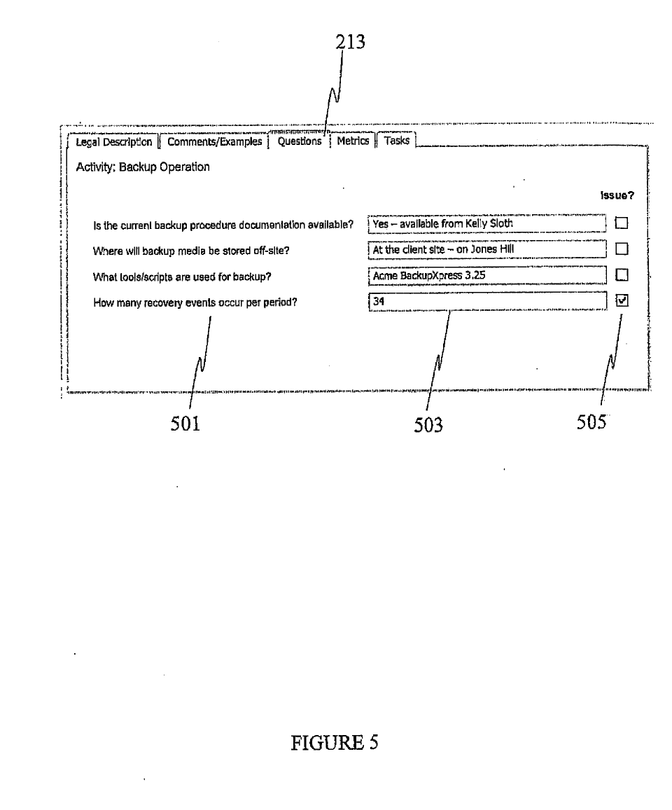

FIG. 5 shows another example of further information in the form of questions which are relevant to the selected activity. As described above, a user selects an activity 203 using the GUI, as shown in FIG. 2, and then selects the Questions tab 213. The processor 301a detects the selection point on the matrix. Further information 501 is then provided in a display panel within the lower pane of the GUI. That is, further information in the form of questions that are associated with the selected activity is retrieved from the database 307 and displayed. The questions are devised to direct the user to retrieve the necessary information from the client and so determine the applicability of the activity to the client's needs and gather required information associated with the specific activity for the provision of the services. Further, the questions enable the retrieval of information associated with the provision of the selected activity to improve the quality of a contract for the technology based services.

After each question, a free form text box 503 is provided to allow the user to enter the answers to the questions. If the user thinks that the answer to any question may be an issue, due to an excessive, unusual or out of the ordinary request, an issue checkbox 505 may be activated.

In the example shown in FIG. 5, the questions provided relate to the specific activity of a backup operation.

The questions 501 include:

“Is the current backup procedure documentation available?”;
“Where will backup media be stored off-site?”;
“What tools/scripts are used for backup?”;
“How many recovery events occur per period?”.

In FIG. 5, answers are shown that have been typed within the free form text boxes 503. For example, for the question related to backup procedure documentation, the answer “yes—available from Kelly Sloth” has been inserted. Further, for the question related to the storage of backup media off-site, the answer “At the client site—on Jones Hill” has been inserted. For the question related to the tools/scripts that are used for backup, the answer “Acme BackupXpress 3.25” has been inserted. For the question related to the number of recovery events that are to occur per period, the answer “34” has been inserted.

Where the user has entered the answer “34” at the time of acquiring the information, it was determined that this may be a particular issue that will require further investigation. Therefore, the issue checkbox 505 has been checked against that answer.

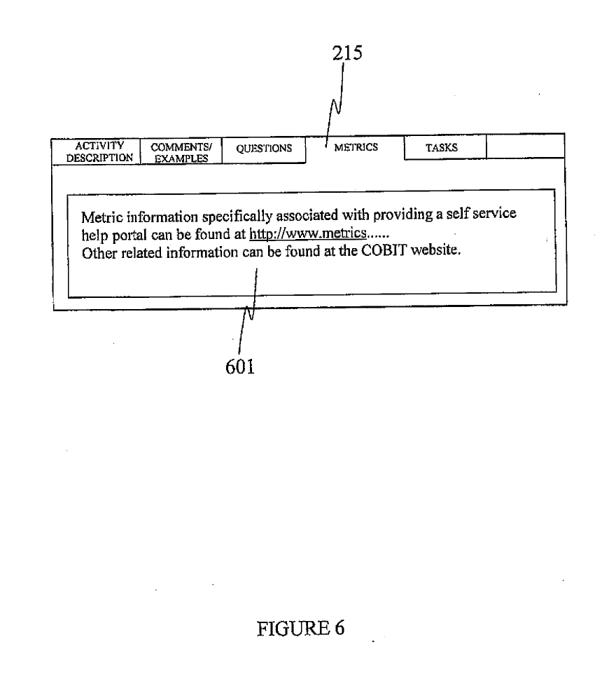

FIG. 6 shows an example of further information in the form of metrics that are relevant to a selected activity. Again, as described above, a user selects an activity 203 using the GUI, as shown in FIG. 2, and then selects the Metrics tab 215. The processor 301a detects the selection point on the matrix. Further information 601 is then provided in a display panel within the lower pane of the GUI. That is, further information in the form of metrics that are associated with the selected activity is retrieved from the database 307 and displayed. In this case, the further information 601 is in the form of metrics that are related to the selected activity. For example, the information indicates how the selected activity can be measured using a common or industry standard, such as Control Objectives for Information and related Technology (COBIT).

For example, as shown in FIG. 6, the information provided in relation to metrics that are associated with the selected activity, i.e. the “Provision” activity under the Self Service Help Portal activity heading may include a paragraph stating:

“Metric information specifically associated with providing a self service help portal can be found at http://www.metrics . . . . Other related information can be found at the COBIT website.”

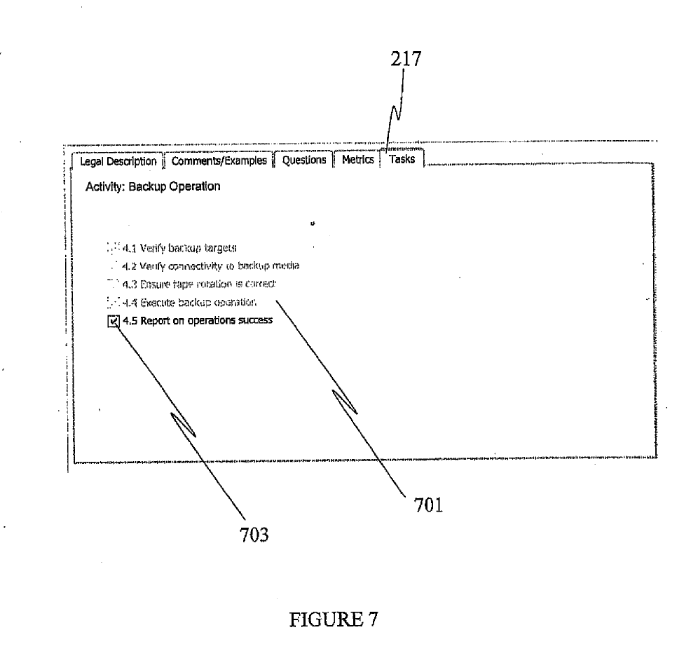

FIG. 7 shows an example of further information in the form of tasks that are relevant to a selected activity. As described above, a user selects an activity 203 using the GUI, as shown in FIG. 2, and then selects the Tasks tab 217. The processor 301a detects the selection point on the matrix. Further information 701 is then provided in a display panel within the lower pane of the GUI. That is, further information in the form of tasks that are associated with the selected activity is retrieved from the database 307 and displayed. In this case, the further information 701 is in the form of tasks that are related to the selected activity.

The task information provided indicates the steps required to carry out the selected activity, and as such can relate to either a task list for a service activity or a set of procedures for a process activity.

As shown in FIG. 7, for the activity “Backup Operation”, tasks 701 are displayed in the GUI. For example, the list of tasks may include:

4.1 Verify backup targets;
4.2 Verify connectivity to backup media;
4.3 Ensure tape rotation is correct;
4.4 Execute backup operation;
4.5 Report on operations success;

For each of these tasks, a check box 703 is provided next to the task description. The check box 703, when checked by the user, indicates that the defined task is relevant to the associated activity for the client. The user thus ascertains, when talking to the client, which of the listed tasks associated with the selected activity are to be provided. This selection allows additional parameters associated with the delivery of the task, for example, directory names, server addresses, run-time parameters, to be provided.

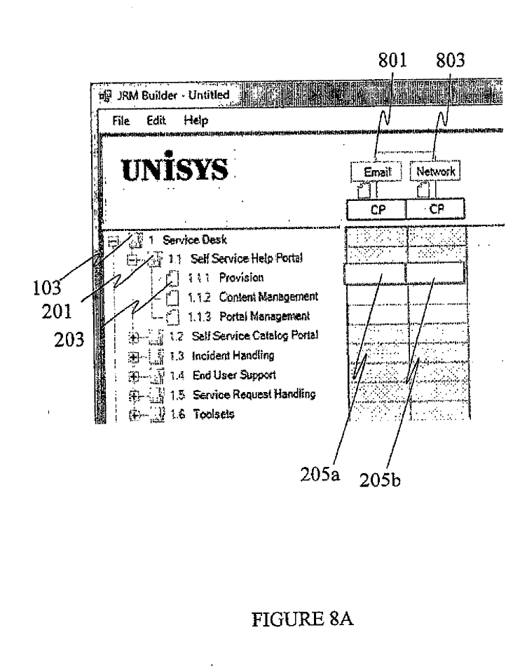

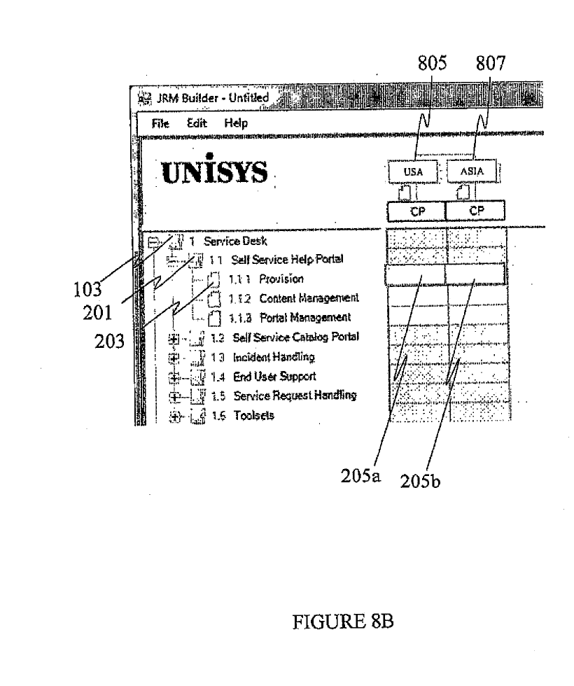

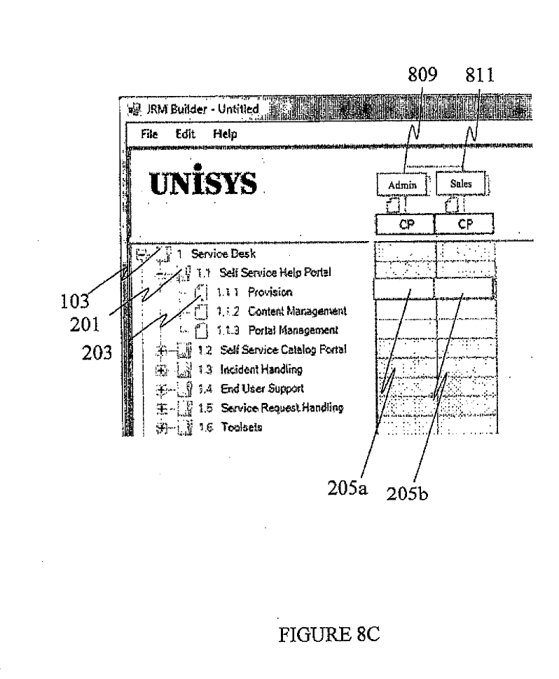

FIG. 8A shows a screen shot of the JRM tool wherein elements of a client's business environment are shown. The business environment in this example has been split up into technologically distinct areas.

The list of services 103 are provided on the left hand side of the screen. Beneath each service 103, a number of activity headings 201 are provided. Further, beneath each activity heading, a number of activities 203 are provided.

In the environment section of the GUI, the client's business environment has been separated into distinct technological areas, such as Email 801 and Network 803. Each of these distinct areas provides a separate column within the matrix. Therefore, an intersection point between activities, such as the “Provision” activity, is provided for each of the distinct elements of the business environment. Referring to FIG. 8a it can be seen that there are now distinct intersection points (205a, 205b) in the matrix for each of the Email element 801 and Network element 803. Therefore, it is possible to identify and insert a relevant service provider for each of these distinct elements of the business environment that are to provide the selected activity.

FIG. 8B shows a further screen shot of the JRM tool wherein elements of a client's business environment are shown. It can be seen from FIG. 8B that the client's business environment can be split up into geographical areas. That is, elements of client's business environment may include the USA 805 or Asia 807. Again, intersection points (205a, 205b) are provided in the matrix for each of the geographically distinct areas for each of the activities 203 listed. This enables different entities to be associated with the provision of the activity in different geographical areas.

FIG. 8C shows a further screen shot of the JRM tool wherein elements of a client's business environment are shown. It can be seen from FIG. 8C that the environment has been separated into distinct business units. That is, the client's business environment has been separated into the administration business unit 809 and the sales business unit 811. In each case, separate intersection points (205a, 205b) in the matrix are provided for each of the activities shown. This enables different entities to be associated with the provision of the activity for different business units.

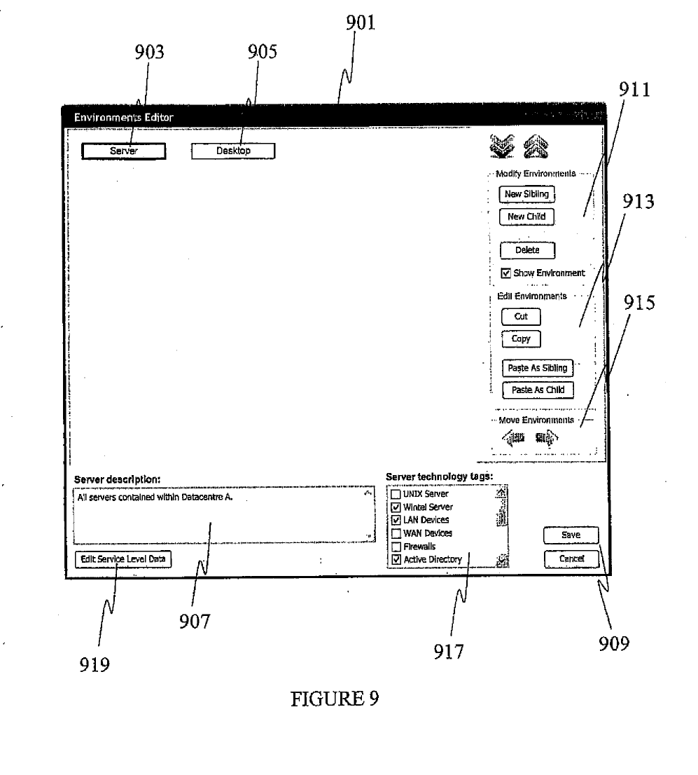

FIG. 9 shows a screen shot of an environments editor.

The environments editor 901 includes a graphical display of elements of the client's business environment. For example, in FIG. 9, the client's business environment has been separated into technological areas and a Server 903 and a Desktop 905 are shown.

Upon a user selecting one of the elements of the environment, for example, the Server 903, a description of that element is provided in a description box 907. For example, if the user selects the element “Server”, the description of the server such as “All servers are contained within data centre A” is provided.

Control buttons 909 are provided to save or cancel changes made to the client's environment.

Further, control buttons 911 are provided to modify the environment. For example, if one of the elements of the environment requires a new sibling, or a new child then the appropriate button can be selected and the new information inserted. Further, if any of the elements of environment are required to be deleted, the delete button may be selected by the user.

Further control buttons 913 that enable the environment to be edited are provided. For example, the ability to cut and copy elements of the environment is provided, as well as the ability to paste elements of the environment as a sibling or child.

Further, the environments may be moved using the move environments control buttons 915.

A tags window 917 is provided. In this example, the tags shown are technology tags. Tags enable specific technologies to be associated with specific elements of the client's business environment. For example, upon selecting the server element of the environment, a number of options are provided in the server technology tags window 917 whereby the user can select which technologies are to be implemented in the client's server environment. For example, the user may select the inclusion of a Unix server, Wintel server, LAN device, WAN device, Firewall etc.

As an alternative, the tags may be associated with a geographical area or a business unit of the clients business rather than a technology device. That is, if the client's business environment is arranged such that it is split up into geographical areas. The tags may be related to business units of the clients business. Therefore, for specific geographical areas, the user may select which business units are effected. Further, as another example, if the client's business environment is split up into business units, the tags may be used to identify specific geographical areas associated with those business units. For example, the accounting section of a client's business may only be located in two or three different locations. By tagging certain items in a group it becomes possible to provide more specific information in relation to the client's business environment, as will be explained in more detail below.

Also provided on the environments editor screen, is an option to select the edit service level data 919. This option allows service level data to be edited as will be explained in more detail below.

With the provision of specific elements of the customer's business environment, it now becomes possible to provide more specific information in relation to selected activities and elements of that environment.

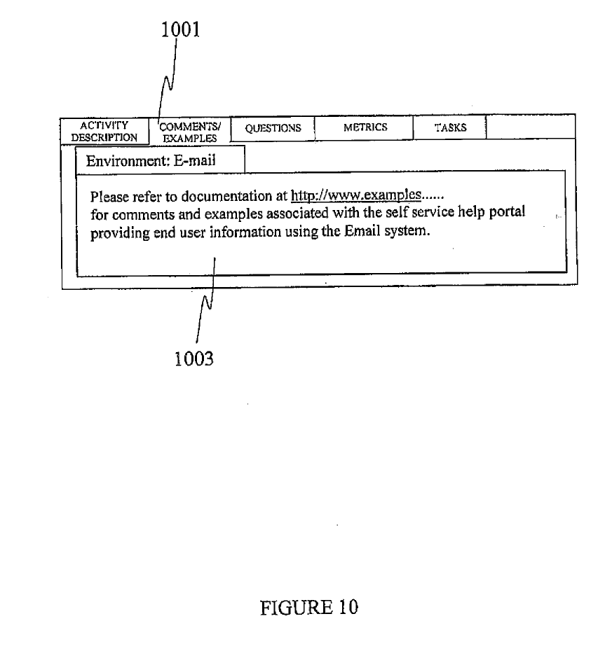

FIG. 10 shows an example of further information in the form of comments or examples that are relevant to a selected activity and an element of the environment.

Upon selecting the comments/examples tab 1001, the user is provided with further information similar to that described above in relation to FIG. 4. However, the information provided in this case is relevant not only to the selected activity but also to the selected environment. In particular, as an example, the environment may be the Email environment. Therefore, the comments and examples information provided is specifically directed towards and related to the email system. For example, the information provided may state:

This information is provided in a display box 1003 in the same manner as previously described.

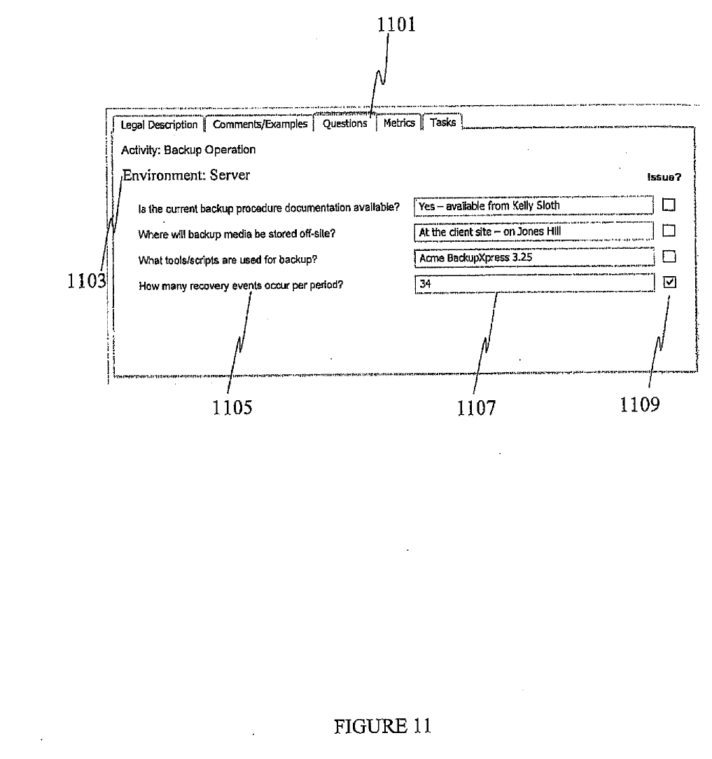

FIG. 11 shows an example of further information in the form of questions that are relevant to a selected activity and element of the environment.

In a similar fashion as discuss above in relation to FIG. 5, further information in the form of questions in provided upon selection of the questions tab 1101. However, in this example, the questions relating to the selected activity, for example “Backup Operation”, are also related to the selected environment, such as the Server environment 1103. The questions 1105 are directly related to those selected activities and environment. Again, answers are provided in text input boxes 1107. Further, if the answers to the questions are considered to be an issue to the user, a check box 1109 is provided.

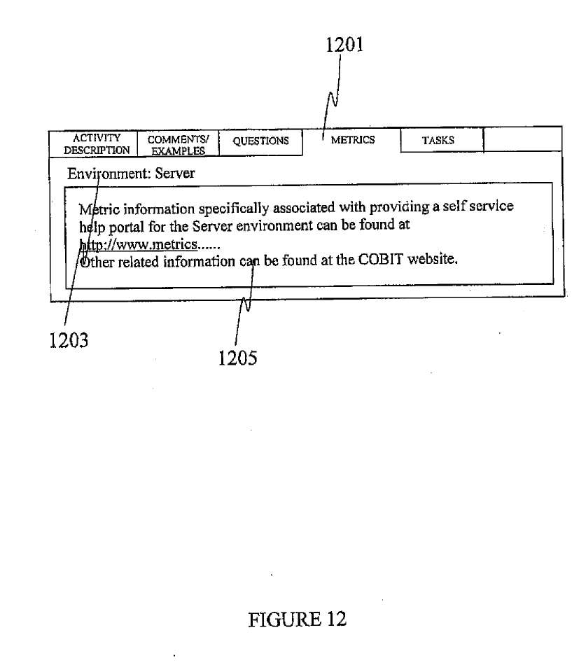

FIG. 12 shows an example of the metrics further information relevant to a selected activity and element of the environment according to this embodiment.

Referring to FIG. 12, similar information as provided with reference to FIG. 6 is provided. However, in this example, the information 1205 is related to both the selected activity, for example “Backup Operation”, and the selected environment 1203, for example “Server”. Therefore, the metric information provided is specifically associated with those activities in that environment.

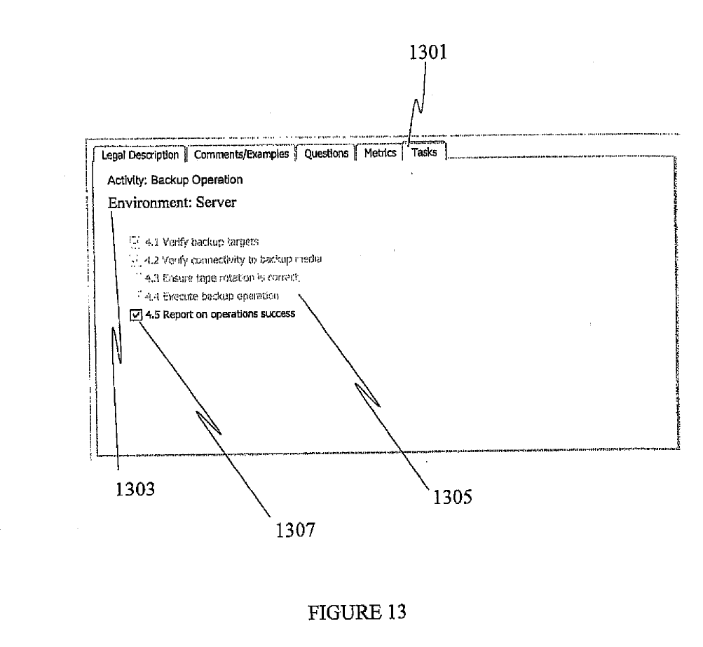

FIG. 13 shows an example of the tasks further information relevant to a selected activity and an element of the environment.

Tasks are provided in a similar manner as described above in relation to FIG. 7. However, in this example, the tasks are specifically related to the activity, for example “Backup Operation”, and the environment, for example “Server”. The tasks are listed when the user selects the task tab 1301. The activity and environment selected are displayed 1303. A list of tasks 1305 are provided along with a select and deselect option 1307. In a similar manner as described above, the user then selects specific tasks that are applicable to the client. The selected tasks are then either included or not included in the information supplied to the contractors. Further, the selected tasks may be used to produce an operation procedures manual (OPM).

As referred to above in relation to FIG. 9 when describing the environments editor, tags are used to associate specific technologies, geographical areas or business units with elements of the environment. The use of the tags enables specific information related to not only the selected activity and the selected environment but also the relevant tagged items to be displayed.

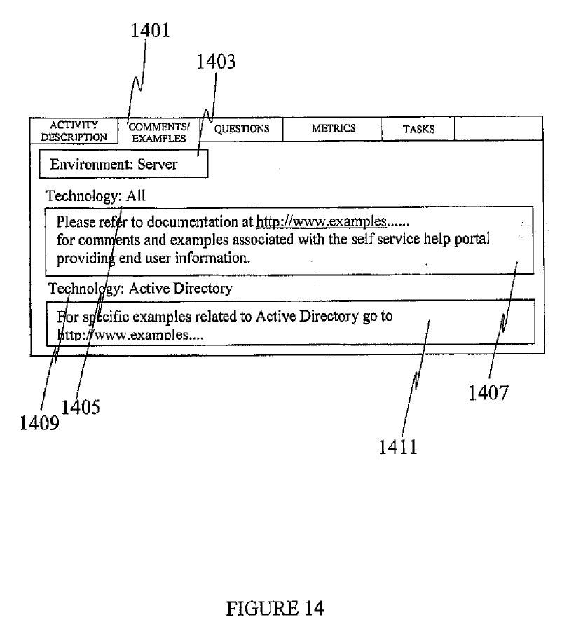

FIG. 14 shows an example of the further information in the form of comments or examples that are relevant to a selected activity, element of the environment and tagged item.

When a user selects the comments/examples tab 1401, the selected environment is displayed 1403, for example “Server”. Further information associated with specific technologies tagged to that element of the environment is also provided.

In this example, the tags are related to the technology associated with the environment. In a first portion of the display, information associated with all technologies 1405 is provided. The information 1407 directs the user to relevant comments and examples for all technologies associated with the Server environment.

Further, for specific technologies such as Active Directory 1309, further information 1311 is provided that is specifically related to that technology. Thus, the user is able to be directed to specific comments and examples associated with certain tagged technologies for the selected environment and activity.

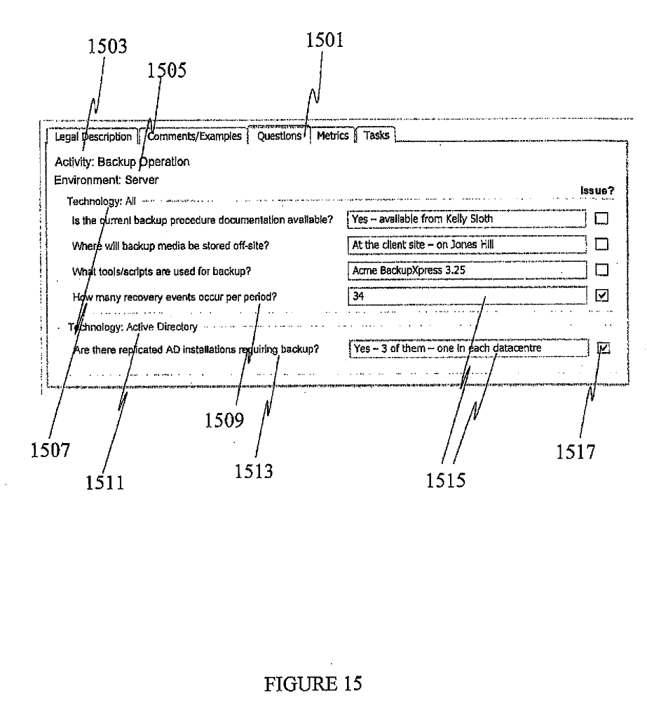

FIG. 15 shows an example of the further information in the form of questions that are relevant to a selected activity, element of the environment and tagged item.

On selection of the questions tab 1501, the selected activity 1503 and environment 1505 are displayed. For example, the activity may be the “Backup Operation” and the environment may be the Server.

A list of questions is then provided that are associated with all technologies 1507 within the server environment. For each of these questions 1509 a space is provided 1515 for inserting the relevant answers.

Further, for other technologies that have been tagged with the Server element of the environment, specific questions such as those directed towards the technology Active Directory 1511 are provided. Again, space is provided for inserting the relevant answer 1515. As described above, issue check boxes 1517 are also provided to indicate whether the question or answer is considered to be an issue by the user.

Examples of questions that may be used include those discussed above in relation to FIG. 5, which may be used for all technologies. Further, the question “Are there replicated AD installations requiring backup?” may be inserted for technologies associated with the Active Directory.

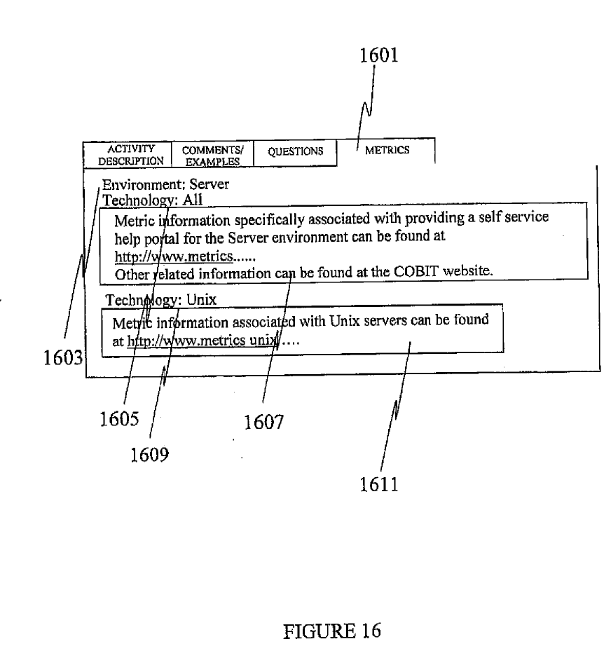

FIG. 16 shows an example of the further information in the form of metrics that are relevant to a selected activity, element of the environment and tagged item

Referring to FIG. 16, similar information as discussed above with reference to FIGS. 6 and 12 is provided. However, in this example, when the metric tab 1601 is pressed, the information displayed is related to the selected activity, for example “Backup Operation”, the selected environment 1603, for example “Server” and specific technologies tagged for the environment selected. Therefore, the metric information provided is specifically associated with those activities in that environment for the tagged technologies.

For example, information relating to all technologies 1605 is displayed in a window 1607, as well as specific information relating to Unix technologies 1609 being displayed in a separate window 1611. In this manner specific metrics information related to the technologies can be displayed and used by the user to determine the needs of the client.

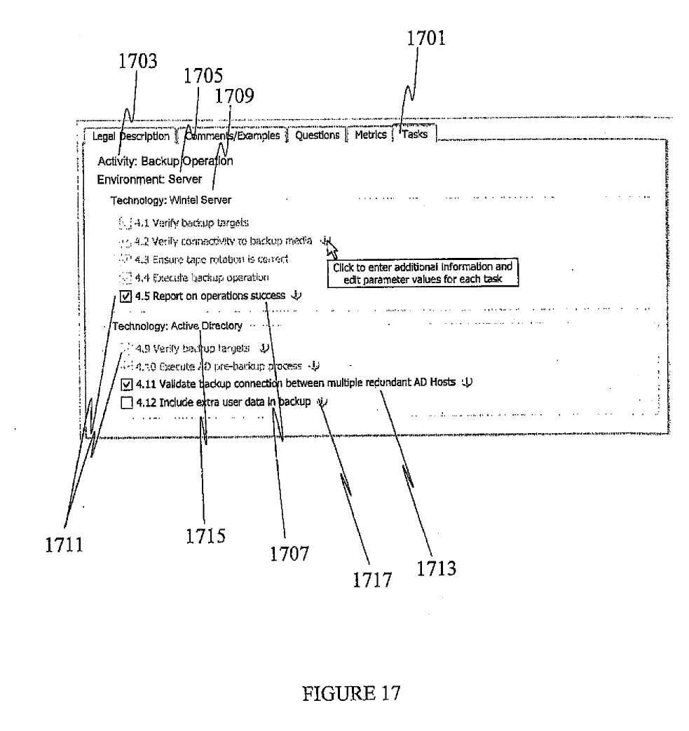

FIG. 17 shows an example of the further information in the form of tasks that are relevant to a selected activity, element of the environment and tagged item.

As shown in FIG. 17, tasks are provided in a similar manner as described above in relation to FIGS. 7 and 13. However, in this example, the tasks are specifically related to the activity, for example “Backup Operations”, the environment, for example “Server” and specific technologies that are tagged to the environment. The tasks are listed upon the user selecting the task tab 1701. The activity and environment selected are displayed 1703 and 1705. A list of tasks 1707 are provided for the Wintel server technologies 1709 along with a select and deselect option 1711. Also, a list of tasks 1713 is provided in a separate window for the Active Directory technology 1715 along with the select and deselect option 1711. In a similar manner as described above, the user then selects specific tasks that are applicable to the client for each of the tagged technologies. The selected tasks are then either included or not included in the information supplied to the contractors. Further, the selected tasks may be used to produce an operation procedures manual (OPM). It will be understood that a further window could be included to provide task information associated with all technologies tagged to the selected environment.

Information icons 1717 are provided next to each task to enable a user to enter additional information and edit parameter values for each of the listed tasks.

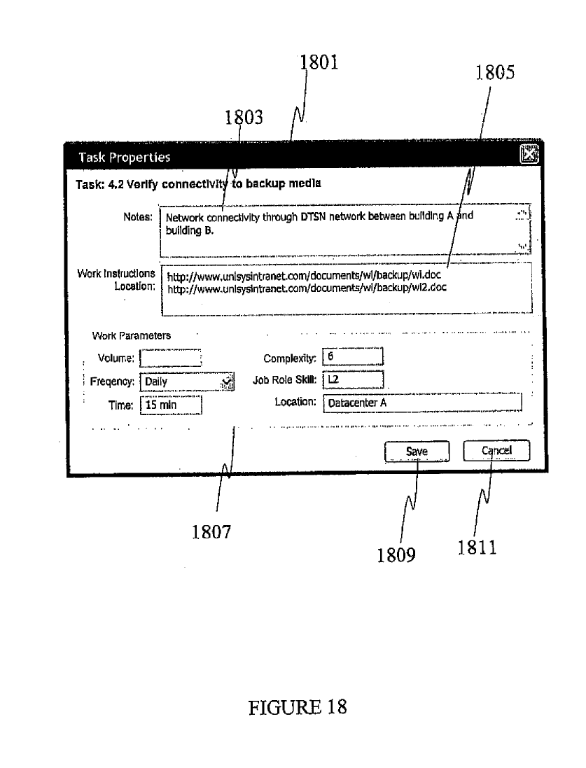

FIG. 18 shows a screen shot of the task properties entry screen.

Upon selecting the information icon 1717 as shown in FIG. 17, a task properties box 1801 is displayed on the GUI. The task properties box 1801 provides further information on the task. For example, the task properties box may include notes 1803 describing the specific task. Further, links 1805 to relevant information associated with how to carry out the specific task may also be provided. In addition, metric values 1807 can be inserted for the specific task selected. One example of the metrics that may be inserted included work parameters such as volume, frequency, time, complexity, job role to skill and location. The user is then able to save 1809 or cancel 1811 the information entered in the task properties box using the save and cancel buttons.

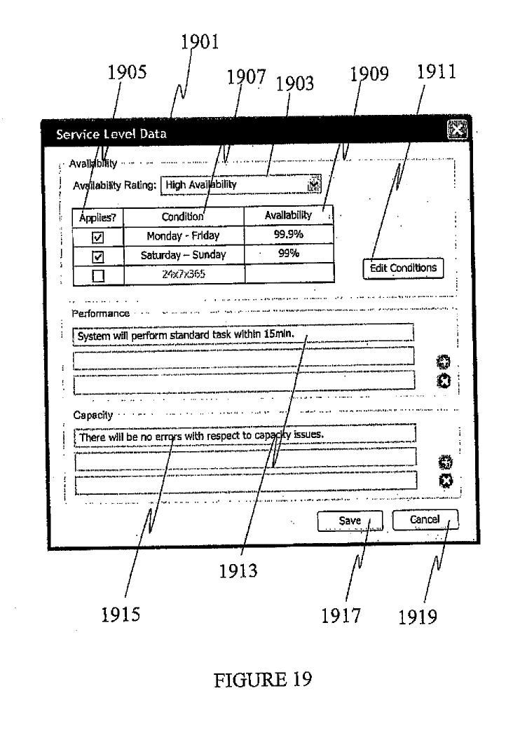

FIG. 19 shows a screen shot of a service level data input screen. As discussed above in relation to FIG. 9, an edit service level data option 919 is provided on the environments editor screen. When a user selects this option they are taken to a service level data input screen 1901 to enable metrics to be inserted. In this example, the service level data is associated with the availability, performance and capacity data for the elements of the business environment. Metric information associated with the availability rating may be entered by selecting a specific availability rating from a drop down icon 1903. For example, if the availability is determined by the user to be high availability, a number of options are provided in a table. The table includes an option to click on a check box 1905 if the condition 1907 and availability rating 1909 applies. For example, if the user decides that the selected element of the environment needs to be available 99% of the time between Monday and Friday, the appropriate selection is made on screen.

Alternatively, if the user feels that the selected element of the environment should be available 99% of the time between Saturday and Sunday, that particular availability selection is made. Alternatively, the user can edit the appropriate conditions for availability and provide different values and time frames. For example, it may be decided that the element of the environment should be available 24 hours a day 7 days a week 365 days a year. In this case, the user can select the edit conditions option 1911 to provide the relevant information. In addition to availability rating information, performance information may also be provided. For example, the free form text box 1913 may be used to enter performance data. In addition, numerical data may also be inserted for identifying performance data.

Also, capacity metric information may also be inserted in the free form text boxes 1615. In addition, numerical data associated with the capacity data may also be inserted.

By using the save button 1917, the user can save all the entered data. If the user wishes to cancel the entered information, the user can press the cancel button 1919. Upon pressing the save button, validity calculations are performed by the processor to ensure the values selected for that part of the environment are valid across the whole environment, as will be explained below.

The availability data input function allows the user to input availability figures based on conditions which are standardised across all environments. The availability rating acts as a preset to set the particular environment to a defined set of availability metrics, and also to group environments together as a particular availability rating/level.

The performance and capacity sections allow the user to enter free-form statements for generic, environment-wide, service level measures, as well as providing an option to enter numerical values that can be automatically checked.

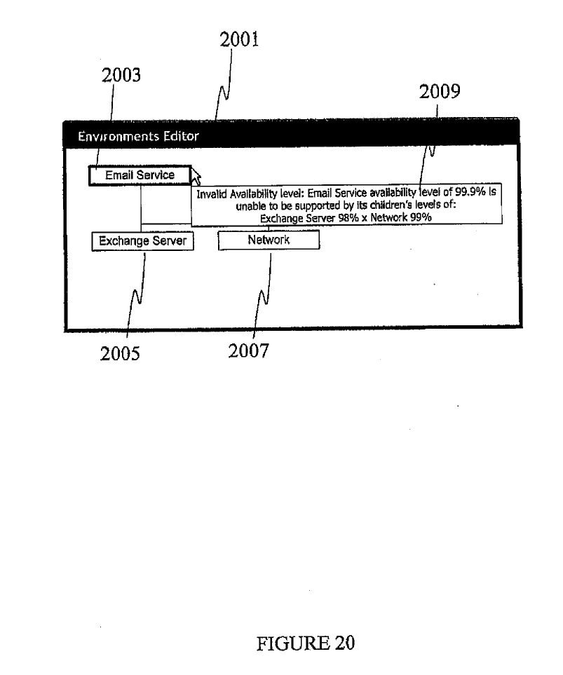

FIG. 20 shows a screen shot of the hierarchy of an environment that is displayed in the environments editor 2001.

As explained above in relation to FIG. 9, the environments editor 2001 is used to describe the client's business environment, whether it is using technologically distinct areas, geographical areas or business units. In each of these cases it is possible to create a hierarchy of each of the different elements in the environment.

For example, as shown in FIG. 20, the parent element 2003 is ‘E-mail Service’, which has two child elements ‘Exchange Server’ 2005 and ‘Network’ 2007. In other words, the Email Service environment is dependant (in terms of availability figures) as a service to the client on the environments Exchange Server and Network.

After the user has entered the metric data on the service level data input screen, a calculation is made by the processor 301a to determine if the entered data is valid. If the data is not valid, a dialogue 2009 is displayed to indicate to the user that there is invalid data. It will be understood that the indication of invalidity, or indeed the indication of validity, can be made in other ways, such as audible or visual signals, or the transmitting of error or validity signals over a network, etc.

The determining step in this embodiment occurs when the save button is clicked on by the user. At that point, the system makes all necessary calculations to determine if the entered or selected values are valid. If the system determines that the values are not valid, a display of the environment is shown with an indicator to show which values are not valid. As an alternative, it will be understood that the determination of validity may be carried out at other points in the process. For example, the calculations may be made as the user enters or selects the appropriate metric values, or upon clicking on a ‘calculate’ or ‘validate’ button.

The standardisation of the availability conditions allows values to be compared between environments and therefore allows some useful calculations to be performed.

An example of this is calculating the validity of availability figures with respect to environment dependencies. Therefore for the Email Service environment to have a valid availability service level, the value of its service level can not be greater than any one of the values of its children—assuming ‘probability dependency’—i.e. the children are multiplied together to get the maximum possible valid value for the parent's availability level. For example, if the availability of the exchange server was provided as 98% and the availability of the Network was provided as 99%, then the maximum valid service level value for the Email service would be 0.98×0.99=0.9702 (97%).

In the screen shot of FIG. 20, it can be seen that the availability data value of 99.9% for the E-mail service is flagged as being invalid based on the above calculations. An indication is provided to show that this can not be supported by the Exchange server and Network.

It will be understood that similar calculations can also be made for suitable numerical values entered in relation to performance data and capacity data.

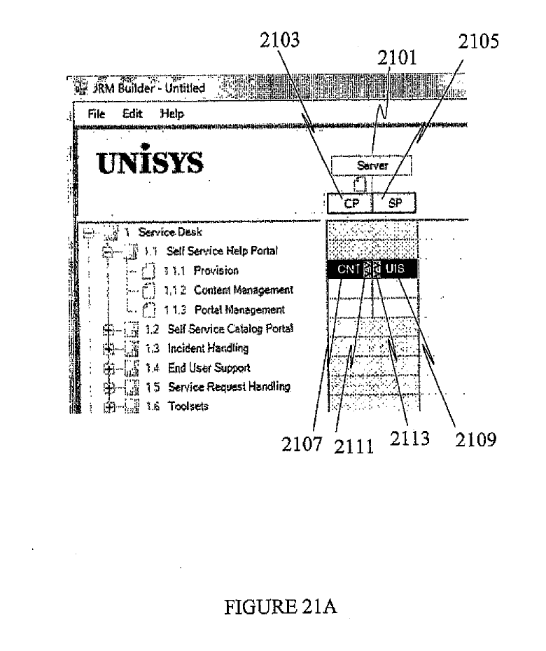

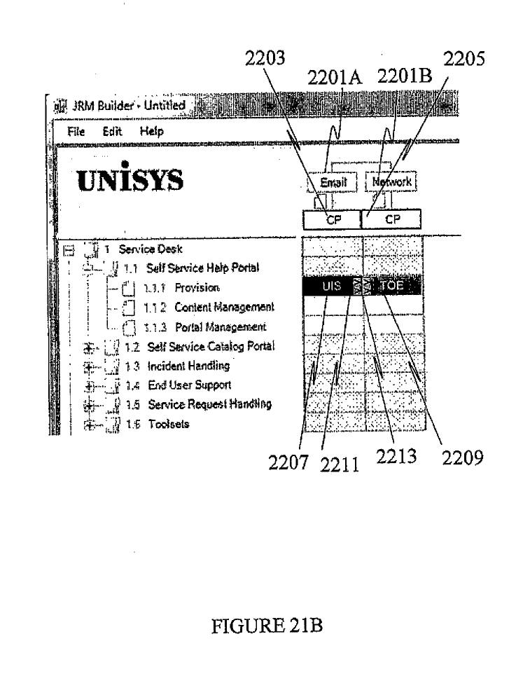

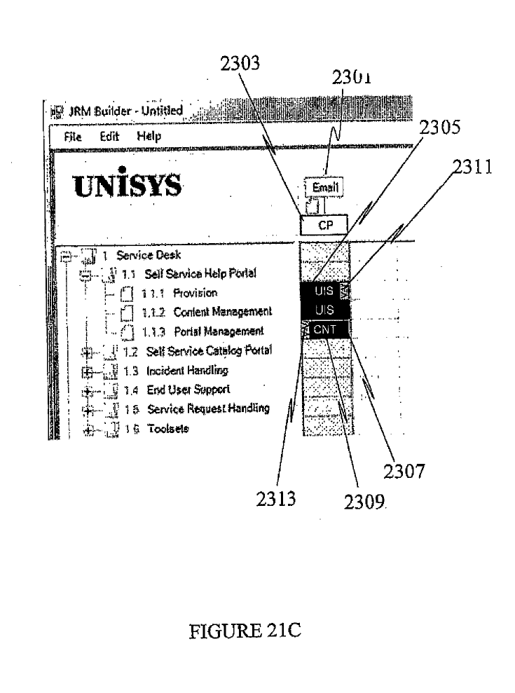

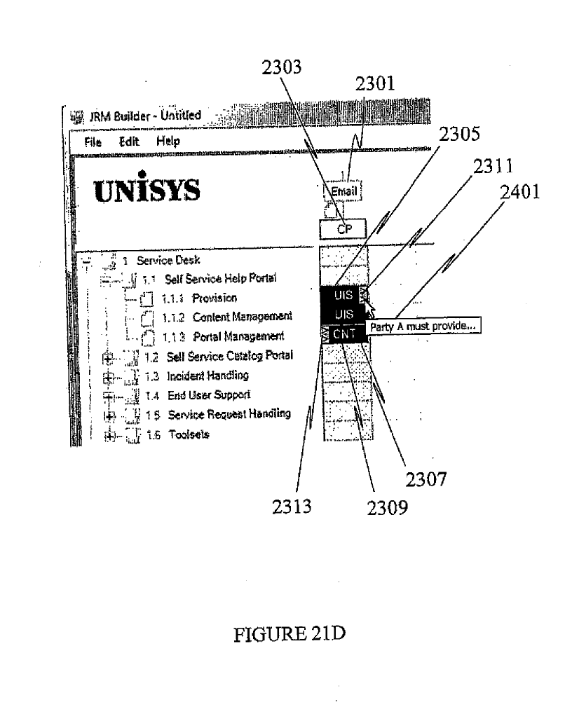

FIG. 21A shows a screen shot of an interaction indicator between parties responsible for a single element of an environment for a single activity according to this embodiment. It will be understood that the client themselves may be responsible for the provision of certain services.

In this example, elements of the client's environment are split up into technological areas, where one such area is ‘Server’ 2101. The matrix includes a number of intersection points with various activities to indicate who the responsible parties are for providing the associated activities in the server environment. The relevant parties responsible for the provision of a certain activity, such as the provision activity for the self service help portal, can be identified as the contracted party (CP) 2103 and the supporting party (SP) 2105. The supported party and contracted party are both responsible for the same element of the client's business environment. That is, the contracted party has been contracted by the client to provide the relevant service, and the supporting party aids the contracted party in the provision of that service.

In order to define clearly how the contracted party and supporting party interact with each other, rules, procedures and conditions may be defined. That is, the nature of the interaction is defined.

The contracted party is identified in the intersection cell 2107 between the selected activity and the contracted party for the element of the environment. The supporting party is also identified in the intersection cell 2109 between the selected activity and the contracted party for the element of the environment. Interaction indicators (2111, 2113) are displayed showing a graphical representation of the direction of interaction.

The interaction is shown in FIG. 21A to be from the contracted party to the supporting party. In this embodiment, the indicator is an arrow, in the form of a series of chevrons. It will be understood that various other forms of indicator may be used.

The following data, for example, can be stored for display or later retrieval for a particular cell intersection:
Conditions of the interaction
   These are stored in a separate globally-accessible list, so all interactions use the same conditions
   The conditions are essentially statements to describe how the interaction takes place, for example: On request from Client, with a defined condition
Definition of interaction artefacts. These may be deliverables, outputs or handover artefacts depending on the type of interaction.
Freeform notes describing any other relevant details of the interaction.

This functionality allows the user to define the interaction between two fields of the same environment—in the particular example shown, the contracted party and supporting party fields. This provides a relatively easy way to map this type of interaction. By using a supporting party field, and defining the interaction in an obvious and standardised way through conditions, the JRM becomes richer in meaning, especially for relatively complex situations where the client and the service provider can both perform many of the same activities, and the actual party which performs an activity in a specific scenario depends on certain conditions.

FIG. 21B shows a screen shot of an interaction indicator between parties for different elements of an environment for a single activity according to this embodiment.

In a further example, the responsible parties are identified as being responsible for different elements of the client's business environment for a particular selected activity. The elements of the environment are displayed, for example, ‘E-mail’ 2201A and ‘Network’ 2201B. An indicator (2203, 2205) is provided below each to indicate the status of the party, i.e. whether it is a contracted party (CP), supporting party (SP) or delivering party (DP). In this case, it is indicated that each party is a contracted party.

The parties are identified in their relevant cells (2207, 2209) in the matrix that intersect with the associated activity. Interaction indicators (2211, 2213) are displayed showing a graphical representation of the direction of interaction from one cell to another across different elements of the client's business environment. The interaction is shown in FIG. 21B to be from the contracted party in the E-mail environment to the contracted party in the Network environment.

The interaction may reflect a multi-sourcing situation where two providers are supporting an environment each and interactions between the environments need to occur to support activities or services that are provided across multiple environments, for example, Service Desk, Incident Management, Configuration Management etc. In this example, the interaction definition could be defined in terms of communication methods, conditions of interaction, escalation conditions/points etc.

FIG. 21C shows a screen shot of an interaction indicator between parties within one element of an environment over different activities.

Within the E-mail environment 2301, a contracted party 2303 is identified. The matrix includes a column to identify the contracted parties that are responsible for the provision of the intersecting activities. One party may be responsible for one activity (Provision), as well as being responsible for other activities, such as ‘Content Management’. In each case the party is identified (2305, 2307) at each of the intersection points with the relevant activity. Another party is identified 2309 at the intersection point with the ‘Portal Management’ activity.

Interaction indicators (2311, 2313) are displayed showing a graphical representation of the direction of interaction from one cell to another, i.e. from one service provider to another. In this case, the interaction is from the service provider providing the ‘Provision’ activity and the service provider providing the ‘Portal Management’ activity.

This type of interaction can be used to define the handover point between activities, which is relevant both between two different parties and within the same party between delivery teams. The handover point can be defined with the inputs and outputs required, as well as the conditions of hand over. For example, the condition may be that certain procedures have been completed before handover.

Further information concerning details of the interaction between cells can be provided when the user places the mouse cursor over one of the connecting icons, along with a tool tip displaying a summary of the interaction.

FIG. 21D shows a screen shot of the display of further interaction information 2413 that is displayed when placing the cursor over the interaction indicator 2401.

Pre-populated packages may be stored so that they can be inserted into the matrix and client environment by the user if applicable to the client's needs. Further, the pre-populated packages may be inserted into the matrix if the client provides certain answers to specific questions.

Therefore, a JRM already populated with fields, responsibilities and notes to reflect a specific service offering may be retrieved and used.

A library of pre-populated packages are stored in the database and reflect service offerings that are typically sold to clients as well as typical generic environment configurations. The user can simply retrieve the preferred offering to populate the JRM.

Service offerings may include items such as:
Desktop Support
SAP Support
Oracle Database Management Services

Examples of typical generic environment configurations include:
Desktop environment with standard support
Server environment with standard support
Network environment with standard support

Pre-populated packages can be linked with specific service catalogue versions, and through this link define which activities will be performed, and by whom, for the environment.

The key benefits of pre-populated environments include:
A decrease in time and effort required to create a JRM overall by filling in many typical values for a particular service/environment
The ability to easily demonstrate and sell packaged service offerings to clients
A guide to JRM creation is provided through the provision of further information and so minimises common mistakes by filling in ‘generally accepted’ activities while identifying more ‘unique and specific’ activities relevant to the client's needs.

### Further Embodiments

It will be understood that the embodiments of the present invention described herein are by way of example only, and that various changes and modifications may be made without departing from the scope of invention.

1. A computer implemented method of defining the outsourcing of technology based services, the method including the steps of:
defining a plurality of technology based services that are to be provided by one or more service providers to a customer;
defining a plurality of activities associated with the services;
displaying the services and activities on a graphical user interface;
detecting a selection of one of the activities; and
displaying further information on the interface based on the selected activity, wherein the further information provides a guide on how to define the outsourcing of the selected activity.

2. The method of claim 1, wherein the further information includes information in the form of at least one of examples, questions, metrics and tasks.

3. The method of claim 2, wherein the further information in the form of examples includes at least one of previously produced reports associated with the selected activity, tools previously used to carry out the selected activity, a list of clients who have previously implemented the activity, photographs, charts, graphs, multimedia or links to alternative sources of information.

4. The method of claim 2, wherein the further information in the form of questions includes questions to enable the determination of whether the selected activity is required by the customer.

5. The method of claim 2, wherein the further information in the form of questions includes questions to enable the retrieval of information associated with the provision of the selected activity to improve the quality of a contract for the technology based services.

6. The method of claim 2, wherein the further information in the form of metrics includes information on how the selected activity is associated with a common or industry standard.

7. The method of claim 2, wherein the further information in the form of tasks includes information identifying the steps required to carry out the selected activity.

8. The method of claim 7, wherein the steps are either a task list for a service activity or a list of procedures for a process activity.

9. The method of claim 1 further including the steps of:
defining elements of a business environment in which the technology based services are to be provided;
displaying the elements of the business environment on the graphical user interface;
detecting the selection of an element of the business environment; and
displaying further information that is based on the selected activity and selected element of the business environment, wherein the further information provides a guide on how to define the outsourcing of the selected activity with reference to the selected element.

10. The method of claim 9, wherein the activities and elements of the business environment are displayed in the form of a matrix, and the step of detecting is carried out by detecting an intersection point on the matrix where the selected activity intersects with the selected element.

11. The method of claim 9 further including the step of defining elements of the business environment by displaying the business environment elements in terms of technology based elements, geographically based elements or business unit elements.

12. The method of claim 9, wherein the further information includes information in the form of at least one of examples, questions, metrics and task information.

13. The method of claim 12, wherein the further information in the form of examples includes at least one of previously produced reports associated with the selected activity and the selected element, and tools previously used to carry out the selected activity as part of the selected element.

14. The method of claim 12, wherein, when the further information is displayed in the form of questions, the method further includes the steps of:
retrieving questions based on the selected element and selected activity; and
displaying the questions.

15. The method of claim 12, wherein, when the further information is displayed in the form of metrics, the method further includes the steps of:
retrieving metrics associated with carrying out the task; and
displaying the metrics.

16. The method of claim 12, wherein, when the further information is displayed in the form of tasks, the method further includes the steps of:
retrieving steps associated with carrying out the task; and
displaying the steps.

17. The method of claim 9 further including the steps of:
linking items in a group of one of specific technologies, geographical areas or business units to the defined elements of the business environment; and
selecting the further information to be displayed based on the items in the group that are linked to the selected environment.

18. The method of claim 17, wherein the further information in the form of examples includes at least one of previously produced reports associated with the selected activity, the selected element and the linked items, and tools previously used to carry out the selected activity as part of the selected element in association with the linked item.

19. The method of claim 17, wherein, when the further information is displayed in the form of questions, the method further includes the steps of:
retrieving questions based on the selected element, selected activity and the linked items; and
displaying the questions.

20. The method of claim 19 further including the step of providing free form text entry boxes to enable the displayed questions to be answered.

21. The method of claim 19 further including the step of providing a check box to enable questions to be identified as a potential issue.

22. The method of claim 19 further including the step of outputting a summary of at least one of answers to the questions, potential issues identified or linked items.

23. The method of claim 17, wherein, when the further information is displayed in the form of tasks, the method further includes the steps of:
retrieving steps associated with carrying out the task based on the selected element, selected activity and the linked items; and
displaying the steps.

24. The method of claim 23 further including the step of displaying check boxes to identify which of the steps are to be applied to the outsourcing of the selected activity.

25. The method of claim 24 further including the step of providing additional information defining properties of the task, wherein the additional information includes links to instructions on how to carry out the task.

26. A computer implemented method of validating metric data during the outsourcing of technology based services, the method including the steps of:
defining a plurality of technology based services that are to be provided by one or more service providers to a customer;
defining elements of a business environment in which the technology based services are to be provided and arranging them in a hierarchy;
displaying metric information for the selected element;
enabling metric data for the elements of the business environment to be received; and
determining if any received metric data is valid across the hierarchy of the business environment.

27. The method of claim 26 wherein metric data can be received by the steps of:
displaying a metric data input page for the selected element of the business environment;
receiving manually entered metric data on the metric data input page; and
storing the manually entered metric data in association with the selected element.

28. The method of claim 26 wherein metric data can be received by the steps of:
displaying pre-defined metric data for the element;
detecting a selection of at least one item of metric data; and
storing the selected item of metric data in association with the selected element.

29. The method of claim 26, wherein the metric data is one of availability data, performance data or capacity data.

30. The method of claim 29, wherein the step of determining includes the steps of:
determining a total value for the metric data of one or more child items in the hierarchy, wherein the child items are a hierarchical level below a parent item;
determining a total value for the metric data of the parent item in the hierarchy;
determining if the total value for the metric data of the child items is at least equal to the total value for the metric data of the parent items; and, upon a positive determination,
providing an indication that the metric data received is valid.

31. A computer implemented method of providing interaction information when defining the outsourcing of technology based services, the method including the steps of:
defining a plurality of technology based services that are to be provided by one or more service providers to a customer;
defining a plurality of activities associated with the services;
defining elements of a business environment in which the technology based services are to be provided;
displaying the services, activities and elements of the business environment on a graphical user interface; and
displaying a graphical indication of the direction of interaction between any two entities, wherein an entity is one of a service provider or the customer.

32. The method of claim 31 further including the step of displaying the graphical indication in the form of an arrow icon that points from a first entity to a second entity, wherein the first entity is required to interact with the second entity.

33. The method of claim 31 further including the step of displaying interaction information when a pointer device icon is positioned over the graphical indication.

34. The method of claim 31, wherein the interaction is between two entities and the graphical indication is displayed to indicate the interaction is either within the same environment for a single activity, across different elements of the business environment for a single activity or across different activities in a single element of the business environment.
